(19) United States
(12) Patent Application Publication
(10) Pub. No.: US 2025/0140252 A1
(43) Pub. Date: May 1, 2025

(54) SYSTEMS AND METHODS FOR VOICE-BASED TRIGGER FOR SUPPLEMENTAL CONTENT

(71) Applicant: VIZIO, INC., Irvine, CA (US)

(72) Inventors: Steve Yum, Irvine, CA (US); William Wang, Fremont, CA (US)

(73) Assignee: VIZIO, INC., Irvine, CA (US)

(21) Appl. No.: 18/924,525

(22) Filed: Oct. 23, 2024

Related U.S. Application Data
(60) Provisional application No. 63/593,132, filed on Oct. 25, 2023.

(51) Int. Cl. G10L 15/22; G10L 15/18; H04N 21/431; H04N 21/439

(52) U.S. Cl. CPC G10L 15/22; G10L 15/1822; H04N 21/4316; H04N 21/4394; G10L 2015/223

(57) ABSTRACT

A media device may perform contextual processing based on media segments that are presented. The media device may receive an identification of a video segment being displayed by a display device from an automated content recognition service. The media device may transmit a notification including information associated with the video segment and a request for audio input. Upon detecting one or more audio segments associated with the notification, the media device may facilitate a presentation of an object associated with the video segment.

### CROSS-REFERENCE TO RELATED APPLICATIONS

The present patent application claims the benefit of priority to U.S. Provisional Patent Application No. 63/593,132 filed Oct. 25, 2023, which is incorporated herein by reference in its entirety for all purposes.

### TECHNICAL FIELD

This disclosure relates generally to audio processing, and more particularly to contextually controlled audio feedback processing by computing devices.

### BACKGROUND

Smart televisions enable the presentation of interactive media (e.g., interactive video, games, etc.) using various input devices (e.g., a remote control, mobile device, etc.). Interactive media may include one or more functions configured to execute upon detecting an input event. Smart televisions may detect the event (e.g., via an input/output interface, communication interface, etc.) and pass a notification of the input event to the interactive media being presented causing the interactive media to execute the one or more functions. Non-interactive media (e.g., such as broadcast television, video, etc.) may not include instructions for executing particular or specific functions of the smart television. As a result, smart televisions may be unable to leverage the interactive functionality available to the smart television when presenting non-interactive content.

### SUMMARY

Methods and systems are described herein for contextual audio processing. The methods may include receiving, from an automated content recognition service, an identification of a video segment, wherein the video segment is being displayed by a display device; transmitting, based on the identification of the video segment, a notification to the display device, the notification including information associated with the video segment and a request for audio input; detecting one or more audio segments associated with the notification; and facilitating, in response to detecting the one or more audio segments, a presentation of an object associated with the video segment.

The systems described herein for contextual audio processing. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example computing device configured to execute contextual audio processing according to aspects of the present disclosure.

FIG. 2 is a block diagram of an example system for contextual audio processing according to aspects of the present disclosure.

FIG. 3 illustrates a diagram of an example process for executing contextual audio processing in computing devices according to aspects of the present disclosure.

FIG. 4 illustrates a flowchart of an example process for contextual audio processing in computing devices according to aspects of the present disclosure.

FIG. 5 illustrates an example computing device architecture of an example computing device that can implement the various techniques described herein according to aspects of the present disclosure.

### DETAILED DESCRIPTION

Systems and methods are described herein for voice-based triggers for supplemental content. Media devices may be configured to present a variety of types of media from a variety of different sources (e.g., over-the-air (OTA), cable, satellite, Internet, etc.). Most of the types of media include non-interactive media that include audiovisual data but may not include instructions for executing other functions of the media device. As a result, many functions of the media device may be inaccessible impacting user experience. The methods and systems described herein provide transmission of instructions in parallel to the media presented by the media device, that when executed cause the media device to execute functions in association with media being presented. Any non-interactive media can become interactive media without modifying the media being received by the media device. In addition, functionality of the media device can be conditional executed in association with non-interactive media or interactive media.

For instance, some content may include contact information (e.g., phone number, quick response (QR) code, etc.) that provides a way for a user to access additional information associated with the content. Since the contact information may be presented for a limited amount of time, it may be difficult for users to execute the contact information (e.g., remember the phone number, take a picture of the QR code, etc.). Instead, the media device may receive instructions to be executed during presentation of the content that monitor input sources of the media device over a time interval that begins when the content is presented and may extend to the termination of the presentation of the specialized content or to some time after the presentation of the specialized content. Upon receiving the input, the media device may execute additional instructions associated with the content. The instructions may cause the media device to present additional information associated with the specialized content, replace the specialized content with substitute specialized content, transmit communications tailored to the user and associated with the specialized content, etc. For example, the content may provide information about a product and when input is received during the time interval, a notification may be transmitted to the user (e.g., to the media device, a mobile device or other device associated with the user, etc.) with additional information about the product, a coupon for the product, additional media associated with the content, combinations thereof, or the like.

The media device may be configured to initiate a trigger that causes instructions to execute upon detecting a particular event. A trigger may be associated with a particular media or media segment to enable detection of events associated with the particular media or the particular media segment and execute contextually related processes. For example, the trigger may be associated with a television show or advertisement such that when the television show or advertisement is presented by the media device, the trigger causes the media device to begin monitoring for a corresponding event of the trigger. An event may be an action executed by a user, particular input received by the media device, execution of particular functions of the media device, execution of instructions, presentation of particular media or a particular media segment, combinations thereof, or the like. For example, an event may correspond to detecting audio input from a microphone interface of the media device where the audio input includes a particular word or phrase spoken by the user of the media device.

In some instances, the media device may define one or more triggers (e.g., based on historical viewing behavior of a user, user input, web browsing activity, etc.). In other instances, the media device may receive a communication defining one or more triggers. A trigger may include identification of the new trigger (e.g., an identifier, etc.), an identification of an event (e.g., particular input from a particular input source, etc.), an identification of a set of instructions to execute in response to detecting the event, an identification of a set of instructions to execute to detect particular media and/or to detect the event, an identification of a time interval over which detecting an occurrence of the event is to cause execution of the instructions, an identification of trigger media (e.g., particular media or a particular media segment that causes the media device to begin monitoring for the occurrence of the event, etc.), an identification of a supplemental media segment to replace particular media or a particular media segment, combinations thereof, or the like. If a trigger is missing information, then the media device may request the missing information from a remote device and/or from the user.

In some instances, the trigger may include instructions that direct the media device to request additional information, supplemental media segments, and/or instructions from a remote device (e.g., a server, a content distribution network (CDN), other device, etc.). The trigger may identify instructions, media or media segments, data, etc. for the media device to retrieve to enable execution of the trigger. For example, the trigger may identify one or more functions to be executed in response to detecting audio input from a microphone interface and direct the media device to retrieve instructions to execute the one or more functions. The media device may request the instructions and, when the audio input is detected, executing the instructions to cause execution of the one or more functions of the media device. For another example, the trigger may identify a supplemental media segment that is to replace a media segment when the media segment is displayed by the media device. The media device may request the supplemental media segment from the remote device. When the media device detects presentation of the media segment (e.g., the event), the media device may replace presentation of the media segment with the supplemental media segment. Since the instructions may be received from a different source than the trigger, a trigger can be defined for different classes of media devices (e.g., disparate device types, etc.). The media device may be configured to retrieve the instructions (e.g., executable instructions, application programming interfaces, etc.), media, etc. to enable the functionality of the trigger.

Once a trigger is defined, the media device may then begin monitoring media segments being presented by the media device for the particular media segment associated with the trigger (e.g., the trigger media). In some instances, the media device may detect the presentation of the trigger media using metadata embedded into the media. Metadata embedded into a media segment may include an identification of a media segment, an identification of one or more media segments to be presented in the future, a schedule of media segments, etc.

In other instances, the media may not include metadata that identifies the media segments being presented. Instead, the media device may identify the media segments being presented using automated content recognition (ACR) services. For example, the media device may generate one or more unknown cues by sampling a video channel and/or audio channel of the media. The media device may generate a cue from pixel values of one or more contiguous sets of pixels of a video frame. Alternatively, or additionally, the unknown cue may include a representation of an audio segment extracted from the media segment (e.g., analog or digital signal, a set of words from a speech-to-text model, etc.). The media device may then compare the unknown cue to known cues associated with known media segments stored in a reference database to identify the media segment currently being presented, the channel, media source, and/or the like.

In some examples, the reference database may be stored in local memory of the media device enabling the media device to identify unknown cues locally. The media device may receive updates to the reference database from an ACR server (or other remote device) to enable the media device to identify new media segments. If the media device cannot identify a matching known cue in the reference database, the media device may transmit the cue to the ACR server for identifications. The ACR server may identify a known cue that corresponds to the unknown cue and transmit an identification of the media segment associated with the known cue to the media device. In other examples, the reference database may be stored in remote memory (e.g., such as memory of the ACR server or other remote device). In those examples, the media device may transmit the cue to the ACR server for identifications. The ACR server may identify a known cue in the reference database that corresponds to the unknown cue. The ACR server may then transmit an identification of the media segment associated with the known cue to the media device.

Once a media segment is identified, the media device may determine if the identified media segment corresponds to the trigger media of the new trigger. If the identified media segment does not correspond to the trigger media of the new trigger, then the media device may wait until the media segment terminates and a new media segment begins. The media device may then identify the new media segment. If the identified media segment does correspond to the trigger media of the new trigger, the media device may instantiate one or more event listeners associated with the trigger to monitor for the event.

The event may correspond to particular input received over a particular interface. The particular interface may include, but is not limited to, microphones, optical sensors, input devices (e.g., mouse, keyboard, remote control or other device configured to remotely control the operation of the media device, a gamepad, and/or the like), network interfaces of the media device (e.g., such as interfaces using Bluetooth, Ethernet, Wi-Fi, Zigbee, Z-Wave, etc.), combinations thereof, or the like. The one or more event listeners may generate an event upon detecting the particular input from the particular interface. The input may be an audio segment (e.g., spoken words or phrases, etc.), an alphanumeric string (e.g., such as a text message, email, input from a remote control, etc.), a graphic (e.g., such as a QR code, image, symbol, etc.), light or light sequence (e.g., such as a camera flash, etc.), and/or the like. The event generated by an event listener may include an identification of the interface that received input, the input that was received, a timestamp corresponding to when the event is received by the media device, combinations thereof, or the like. The event listener may be terminated once the time interval associated with the new trigger expires.

The media device may execute different processes based on the generated event. For example, if the event corresponds to audio input from a microphone, the media device may transmit a communication to a device associated with a user of the media device, a communication to a user profile, a communication to device associated with the identified media segment that corresponds to the event, etc. If the event corresponds to input from a network interface, the media device may be configured to present the supplemental media segment, restart the currently presented media segment, present other media segments, present information associated with the identified media segment, transmit instructions that may be executed by the device that transmitted the input (e.g., to present media, navigated to a webpage, subscribe to push notification associated with the media segment, download an application or service, transmit a communication to a remote device, etc.), combinations thereof, or the like.

The media device may also execute different processes based on the input received that corresponds to the event. For example, the media device may present a media segment associated with a product. The media segment may present an indication that additional information or a product object (e.g., such as a coupon, or the like) can be received by providing particular input. If the user provides the particular input by, for example, speaking a particular word or phrase identified in the media segment, the media device may present the additional information and/or transmit the product object to a device or user profile (e.g., email address, etc.) associated with the user, etc. If the user provides a different input such as a different word or phrase, the media device may present the additional information without transmitting the product object, transmit the product object without presenting the additional information, represent the supplemental media segment, restart the trigger media from the beginning, present a substitute media segment associated with the same product, present a substitute media segment associated with a different product or service, terminate the event listener, combinations thereof, or the like.

In an illustrative example, a media device (e.g., mobile device, tablet, computing device, television, etc.) may receive an identification of a video segment from an automated content recognition service. The identification of the video segment may correspond to a video segment that is currently being presented by the media device. For example, the media device may receive a request to initiate a trigger from a remote device. The trigger may cause the media device to execute one or more processes in response to detecting that a particular media segment is being displayed by the media device. Upon initiating a trigger, the media device may begin transmitting one or more cues derived from the video channel and/or the audio channel of the video segment to an automated content recognition service to determine if the media segment currently being presented corresponds to the particular media segment corresponding a trigger.

A cue may be a data structure that includes a representation of pixel values from one or more contiguous pixels of a video frame extracted from the video channel. Alternatively, or additionally, the data structure may include a representation of one or more audio segments extracted from an audio channel. Alternatively, or additionally, the data structure may also include metadata derived from the video segment by the media device such as, but not limited to, an identification of a channel or media source, a timestamp corresponding to generation of the cue, a time interval indicating a time since the video segmented started, information associated with the media device (e.g., an identifier of the media device, a device type of the media device, hardware and/or software installed on the media device, an Internet Protocol address, etc.), combinations thereof, or the like. The media device may then transmit the one or more cues to the automated content recognition service.

The automated content recognition service may be a component of the media device and/or a component of a remote device (e.g., such as a server, content provider, or the like). The automated content recognition service may include or have access to a database of known cues associated with known media segments. Upon receiving an unknown cue, the automated content recognition service may identify a closest matching known cue in the database (e.g., as determined by a distance algorithm, pattern matching, a machine-learning model, and/or the like). The remote device may then assign the identifier of the known media segment of the closest matching known cue to the unknown cue. The automated content recognition service may transmit the identifier to the media device.

The media device may transmit a notification to a display device of the media device based on the identification of the video segment. The display device may be a component of the media device (e.g., the component that displays the video component of the segment). Alternatively, the display device may be a device connected to the media device (e.g., via a High-Definition Multimedia Interface (HDMI) cable, a DisplayPort cable, a network connection, etc.). Alternatively, the media device may transmit the notification to a device associated with the display device or a user thereof (e.g., such as a mobile device, etc.). The notification may include information associated with the video segment and a request for input. The notification may include alphanumeric text, an image, video, an audio segment, combinations thereof, or the like. The notification may indicate one or more options for input and one or more interfaces over which the one or more options for input may be transmitted. For example, the notification may include an alphanumeric text such as: “Say ‘pizza’ to receive a coupon for your next order”.

The media device may detect one or more audio segments associated with the notification. For audio-based inputs, the media device may include a speech-to-text model configured to translate audio into an alphanumeric string. The media device may compare the alphanumeric string to the requested input to determine if the requested input has been provided. Returning to the previous example, the media device may determine if the alphanumeric string includes the word “pizza”. In some instances, the media device may also determine if the alphanumeric string corresponds to common variations of the requested input (e.g., slang, different languages, synonyms, etc.). For non-audio-based inputs (e.g., text, email, input from a remote control, etc.), the media device may directly compare the input to the requested input.

In some instances, the media device may monitor for the one or more audio segments during presentation of the identified media segment. If the one or more audio segments are received after the presentation of the identified media segment terminates (e.g., the media device identifies a new media segment being presented), then media device may ignore incoming audio segments. In other instances, the media device may monitor for the one or more audio segments over a time interval that is greater than the presentation time of the identified media segment. The time interval may begin upon presentation of the notification and terminate at some time after the termination of the media segment to give a user more time to provide the requested input. For example, the time interval may be 30 minutes, 1 hour, 24 hours, etc.). The time interval may be defined when the trigger is defined and communicated to the user with the notification. Continuing the previous example, the notification may include “Say ‘pizza’ in the next 24 hours to receive a coupon for your next order”.

The media device may then facilitate a presentation of an object associated with the video segment in response to detecting the one or more audio segments. Facilitating presentation of the object may include, but is not limited to, displaying a representation of the object (e.g., alphanumeric text, image, video, etc. associated with the object, a serial number or product code, etc.), transmitting the object to a device associated with the media device (e.g., such as a mobile device, tablet, computing device, etc.), transmitting the object to a user profile (e.g., such as an email address, a profile associated with product or service of the identified video segment, an entity identified in the identified video segment, etc.) associated with a user of the media device (e.g., such as a user identified using the one or more audio segments, etc.), combinations thereof, or the like. Returning to the previous example, after detecting the user say “pizza”, the media device may transmit the coupon to a mobile device of the user.

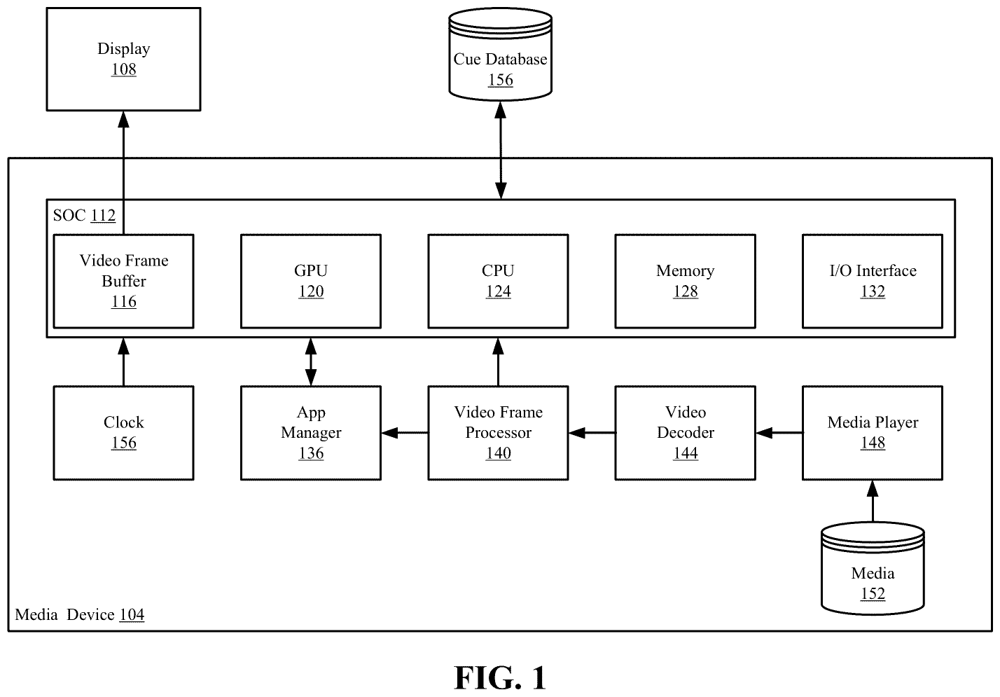

FIG. 1 illustrates a block diagram of an example computing device configured to execute contextual audio processing according to aspects of the present disclosure. Media device 104 may include one or processing components (e.g., system-on-a-chip, central processing units, application-specific integrated circuits, field programmable gate arrays, and/or the like), memories (e.g., volatile and non-volatile memories, databases, etc.), network processors (e.g., including Wi-Fi transceivers, Bluetooth transceivers, and/or other transceivers, etc.), and one or more sensors.

Media device 104 may be configured to present media to one or more users using display 108 and/or one or more wireless devices connected via a network processor (e.g., such as other display devices, mobile devices, tablets, and/or the like). Media device 104 may retrieve the media from media database 152 (or alternatively receiving media from one or more broadcast sources, a remote source via a network processor, an external device, etc.). The media may be loaded by media player 148, which may process the media based on the container of the video (e.g., MPEG-4, QuickTime Movie, Wavefile Audio File Format, Audio Video Interleave, etc.). Media player 148 may pass the media to video decoder 144, which decodes the video into a sequence of video frames that can be displayed by display 108. The sequence of video frames may be passed to video frame processor 140 in preparation for display. Alternatively, media may be generated by an interactive service operating within app manager 136. App manager 136 may pass the sequence of frames generated by the interactive service to video frame processor 140.

The sequence of video frames may be passed to system-on-a-chip (SOC) 112. SOC 112 may include processing components configured to enable the presentation of the sequence of video components and/or audio components. SOC 112 may include central processing unit (CPU) 124, graphics processing unit (GPU) 120, memory 128 (e.g., volatile memories such as random-access memory or read-only memory, non-volatile memory (e.g., such as magnetic, flash, etc.), input/output interfaces 132, and video frame buffer 116.

SOC 112 may generate a cue from one or more video fames stored in video frame buffer 116 prior to or as the one or more video frames are presented by display 108. A cue may be generated from one or more pixel arrays (also referred to as a pixel patch) of a video frame. A pixel patch can be any arbitrary shape or pattern such as (but not limited to) a y×z pixel array, including y pixels horizontally by z pixels vertically from the video frame. A pixel can include color values, such as a red, a green, and a blue value and intensity values. The color values for a pixel can be represented by an eight-bit binary value for each color. Other suitable color values that can be used to represent colors of a pixel include luma and chroma (Y, Cb, Cr, also called YUV) values or any other suitable color values.

SOC 112 may derive a mean value for each cue. The mean value may be a 4-bit data record representative of the cue. The display device may generate the cue by aggregating the average value for each pixel patch and adding a timestamp that corresponds to the frame from which the pixel patches were obtained. The timestamp may correspond to epoch time (e.g., which may represent the total elapsed time in fractions of a second since midnight, Jan. 1, 1970), a predetermined start time, an offset time (e.g., from the start of a media being presented or when the display device was powered on, etc.), or the like. The cue may also include metadata, which can include any information about a media being presented, such as a program identifier, a program time, a program length, or any other information (if known).

In some examples, a cue may be derived from any number of pixels patches obtained from a single video frame. Increasing the quantity of pixel patches included in a cue increases the data size of the cue, which may increase the processing load of the display device and the processing load of one or more cloud networks that may operate to identify content. For example, a cue derived from 5 pixel patches may correspond to 600-bits of data (24-bits per pixel patch times 5 pixel patches) not including the timestamp and any metadata. Increasing the quantity of video patches obtained from a video frame may increase the accuracy of boundary detection and content identification at the expense of increasing the processing load. Decreasing the quantity of video patches obtained from a video frame may decrease the accuracy of boundary detection and content identification while also decreasing the processing load of the display device. The display device may dynamically determine whether to generate cues using more or less pixel patches based on a target accuracy and/or processing load of the display devices.

Unknown cues may be compared to known cues of known media stored in database 156 to identify the media segment corresponding to the unknown cue. Media device may use a distance algorithm (e.g., Euclidean, Cosine, Haversine, Minkowski, etc.) or other matching algorithm to identify a closest known cue to an unknown cue. If the distance is less than a threshold distance, SOC 112 may assign the identifier of the known cue to the unknown cue thereby identifying the media segment that the unknown cue was derived from. Cue database 156 may be a component of media device 104 (e.g., stored in memory 128 or other memory of media device 104 (not shown)) or may be a remote component (as shown).

Upon identifying the media being presented, media device 104 may determine if there is a trigger associated with the media. Triggers may be stored in memory 128 and define processes for providing contextual presentation of media based on input associated with media being presented. A trigger may define: a notification to be presented upon detecting a media segment is being presented; an identification of input requested in response to presenting the notification, identification of a time interval over which input will be accepted, an identification of one or more processes to execute in response to detecting input within the time interval, and/or the like.

If media device 104 identifies a trigger associated with the identified media, media device 104 may initiate the trigger. Initiating the trigger may include presenting a notification to a user of media device 104 (e.g., via display 108 and/or via a network interfaces of media device 104) requesting input from the user. The notification may include alphanumeric text, an image, a video segment, an audio segment, or the like. if the notification is to be presented by display 108, the notification may be presented on top of the media segment being presented (e.g., via a pop-up window, or the like) for a predetermined time interval. Alternatively, the notification may be included in the identified media segment such that media device 104 need not present additional content separate from the media being presented.

Media device 104 may initiate an event listener upon determining that the identified media is associated with a trigger (and/or upon presenting the notification, etc.). The event listener may be a process executed by CPU 124 that monitors I/O interfaces 132 for particular input. Upon detecting input from a particular input interface (e.g., as identified by the trigger, etc.) or from any input interface, SOC 112 may process the input to determine if the input corresponds to input identified by the trigger. For example, the notification may request particular input (e.g., “Say ‘pizza’ in the next 24 hours to receive a coupon.”) and the event listener may monitor an audio interface (e.g., microphone, etc.), for audio input. Upon detecting an audio segment, SOC 112 may process the audio segment (e.g., speech-to-text, etc.) to determine if the audio segment corresponds to the input requested by the trigger (e.g., the word “pizza”, etc.).

SOC 112 may include, or access, one or more speech-to-text models configured to convert audio segments into an alphanumeric string. In some instances, the one or more speech-to-text models may include one or more machine-learning models. The machine-learning models may output an alphanumeric string that corresponds to the audio segment. SOC 112 may then compare the alphanumeric string to the input requested by the trigger. Alternative, SOC 112 may transmit the audio segment to a server for identification. The server may return the alphanumeric string corresponding to the audio segment and/or an indication of whether the audio segment corresponds to the input requested by the trigger.

In some examples, the machine-learning models may include an additional classification layer configured to identify a speaker of the audio segment. The additional classification layer may be trained based on ambient audio detected by I/O interface 132. In some instances, the ambient audio may be filtered before training to avoid the audio channel of the media presented by media device 104 from being included. The additional classification layer may be configured to distinguish between speakers that use media device 104 and/or identify those speakers (e.g., by name and/or by user identifier, etc.). Alternatively, a separate machine-learning model may be used to distinguish between speakers and/or identify a speaker.

The one or more machine-learning models of the speech-to-text models may include any type of machine-learning model. Examples of such machine-learning models include, but are not limited to, neural networks such as recurrent neural networks (e.g., long short-term memory (LSTM), mask recurrent neural networks, etc.), you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, and/or the like. In implementations with additional classification layers, the classification layers may be part of one of the aforementioned machine-learning models or a separate machine-learning model. Examples of such classification layers include, but are not limited to, one or more of Naïve Bayes, logistic regression models, perceptrons, support vector machine, random forest models, linear discriminant analyses models, k-nearest neighbor, gradient boosting, combinations thereof, and/or the like.

The one or more machine-learning models may be trained using audio segments derived from media presented to and/or presentable by media device 104 (e.g., broadcast media, streaming media, etc.) to tailor the training of the one or more machine-learning model to types of audio segments that the one or more machine-learning models will process at runtime (e.g., post training). If the one or more machine-learning models are trained by media device 104, then media device 104 may sample media presented by media device 104 over time to gather training data usable to train the one or more machine-learning models. Alternatively, or additionally, media device 104 may receive audio segments for the training data and/or the training data from one or more remote devices. If the one or more machine-learning models are trained by a remote device, the remote device may sample multiple media sources based on the types of media presentable by media device 104. Alternatively, one or more machine-learning models may be trained using audio segments derived any source (e.g., media presentable by media device 104, other broadcast media such as radio or music, audiobooks, speeches, manually generated media, trained text-to-speech models, any other media source, and/or combinations thereof, and/or the like). In some examples, data may be augmented with additional training data (e.g., procedurally generated data, manually generated data, combinations thereof, and/or the like) and/or metadata (e.g., labels for supervised learning, features derived from the training data, combinations thereof, and/or the like).

The one or more machine-learning models may be trained using supervised learning, unsupervised learning, semi-supervised learning, transfer learning, metalearning, reinforcement learning, combinations thereof, or the like. The one or more machine-learning models may be trained for a predetermined time interval, a predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

In some other instances, the one or more speech-to-text models may not include machine-learning and instead use instructions that perform spectral pattern analysis. The spectral pattern analysis converts unknown audio segments into a frequency domain and compares portions of the audio segments in the frequency domain to spectral features corresponding to known sounds or words. If a portion of an unknown audio segment matches one or more spectral features of a known sound or word, the known sound or word is assigned to the unknown audio segment.

In some other instances, the one or more speech-to-text models may include a combination of one or more machine-learning models and spectral pattern matching.

Media device 104 may execute one or more processes in response to processing the audio segment. For example, if the alphanumeric string corresponds to the input requested by the trigger, the media device 104 may facilitate transmission of a product object to the user (e.g., a user registered with media device 104, a user identified as the user that provided the audio segment, etc.). Media device 104 may present the product object via display 108, transmit a representation of product object to a mobile device associated with the user via I/O interface 132 (e.g., via a Wi-Fi connection, Ethernet connection, Bluetooth connection, etc. with the Internet or with the mobile device, etc.), a user profile (e.g., such as an email address, an account with an entity presented the media segment, etc.), combinations thereof, or the like. The trigger may include instructions that may execute the one or more processes. The particular process executed may be dependent on the input requested, the input received (e.g., the alphanumeric string, etc.), and/or the interface over which the input is received (e.g., remote controller, microphone, camera, network interface, etc.).

The following are example processes of the one or more processes: if the alphanumeric string corresponds termination conditions (e.g., “stop”, “cancel”, “terminate”, etc.), media device 104 may prevent further processing associated with the trigger and/or terminate presentation of the identified media segment (e.g., if it is still currently being presented). If the alphanumeric string corresponds to information conditions (e.g., “more information”, “information”, “who is . . . ”, “what is . . . ”, etc.), media device 104 may present additional information associated with the identified media segment such as, but not limited to information associated with products depicted in the identified media segment, services depicted in the identified media segment, actors, directors, settings, filming locations, etc. The additional information may be provided with the trigger and/or requested upon detecting the alphanumeric string. The additional information may be presented within a window over a portion of the media being presented by display 108. If the alphanumeric string presentation conditions (e.g., “start over”, “restart”, etc.), media device 104 may restart the identified media segment (if it is currently being presented) or play the identified media segment from the beginning (e.g., pausing media that is currently being presented, presenting the identified media segment, and returning to the paused media upon termination of the identified media segment, etc.). If the alphanumeric string corresponds to alternative presentation conditions (e.g., “replace”, “play alternative”, etc.), media device 104 may replace the identified media segment with a substitute media segment. The substitute media segment may be associated with a same product or service as the identified media segment (e.g., a different advertisement for a same product or service) or may be associated with a different product or service (e.g., an advertisement for some other product or service).

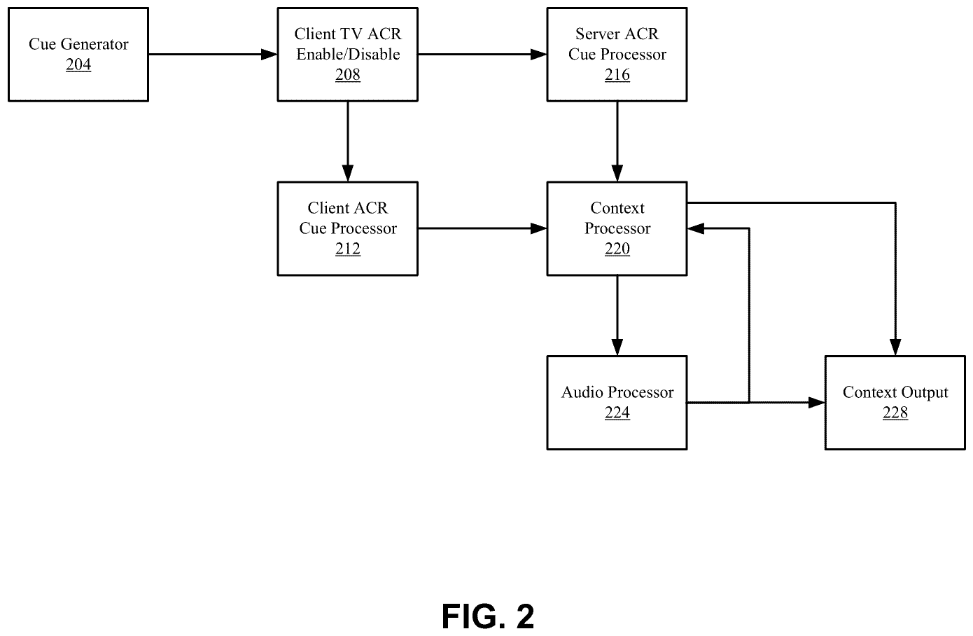

FIG. 2 is a block diagram of an example system for contextual audio processing according to aspects of the present disclosure. A media device may perform contextual audio processing based partially on a media segment being presented by the media device. In some instances, a media device may receive a trigger defining a contextual processing context to be associated with a particular media segment. The trigger may identify the particular media segment (e.g., an identifier, one or more cues of the particular media segment, etc.), audio input configured to trigger a contextual process, and an identification of one or more contextual processes. The instructions to enable execution of identifying the particular media segment, receiving and/or processing audio input, one or more contextual processes, etc. may be included in the trigger, obtained by the media device in response to receiving the trigger, and/or stored by the media device. In some instances, the trigger may be received via a network interface of the media device. In other instances, the trigger may be embedded into the media stream (e.g., as metadata, a watermarks, etc.) being presented by the media device.

The media device may monitor a media stream identify a media segment within the media stream that is being presented. In some instances, the media device may only monitor the media stream when there is a trigger stored in memory to prevent consuming processing resources when there is no trigger. If the media device determines that a trigger is stored in memory, the media device may execute a monitor process. The monitor process may cause cue generator 204 to begin generating cues usable to identify the media that is being presented by the media device. In some examples. cue generator 204 may generate cues in regular intervals (e.g., every 1 seconds, every 1 minute, 5 minutes, etc.). The regular intervals may vary based on a determination of whether the current media segment being presented is a new media segment (e.g., changes in average luminance and/or chrominance, a machine-learning model, etc.). Upon detecting that a new media segment is being presented, cue generator 204 temporarily increase the rate of generating cues until the media segment is identified. Cue generator 204 may then return to reduce rate. For example, cue generator 204 may generate cues ever 3 minutes until detecting that a new media segment is being presented (e.g., a new commercial, television show, movie, etc.). Cue generator 204 may then generate cues ever second until the new media segment is identified. Cue generator 204 may then return to generating cues every 3 minutes. The time intervals described (e.g., both the regular rate and the increased rate) may be individually selected based on characteristics of the media segment currently being presented, characteristics of the media segment that is anticipated to be presented next, user input, previous iterations of cue generator 204, a machine-learning model, combinations thereof, or the like.

In other examples, cue generator 204 may generate cues upon detecting a change in the media being presented by the media device. For example, cue generator 204 may detect a change in the average luminance and/or chrominance of the media being presented over one or more video frames to detect a change in the media being presented (e.g., a new media segment). Cue generator 204 may determine that a new media segment is being presented when the difference in the average luminance and/or chrominance of a video frame relative to a previous video frame is greater than a first threshold and/or less than a second threshold. By calculating the difference in average luminance and/or chrominance over multiple sets of video frames, the media device can detect fade-to-black, fade-from-black, and scene changes that may be characteristic of a change in media being presented. Additionally, or alternatively, the media device may use a machine-learning model to predict a likelihood that the current media segment being presented is different from the previous media segment presented. The machine-learning model may be a classifier configured to process sets of video frames (and/or audio associated with the video frames) to determine if a first video frame corresponds to a same media segment as a preceding second video frame. Examples of machine-learning models include, but are not limited to, deep learning networks, convolutional neural networks, recurrent neural networks, Naïve Bayes, support vector machine, k-nearest neighbor, perceptron, logistic regression, and/or the like. If the confidence of the prediction is greater than a threshold, then the media device may determine that new media is being presented. Upon detecting that a new media segment is being generated, cue generator 204 may begin generating cues from the media segment in regular intervals as previously described.

The media device may include a register flag, client TV ACR enable/disable 208, usable to enable and disable content recognition. In some instances, the register flag may be set to true (or ‘1’ or ‘on’, etc.) to enable content recognition by the media device. The register flag may be set to false (or ‘0’ or ‘off’, etc.) to enable content recognition by an ACR server. In some instances, the register flag may be toggled by a resource allocation process to allocate processing resources of the media device as needed. For example, if processing resources are low or if additional processing resources are requested by a process with higher priority than the content recognition process, then the register flag may be set to false (or ‘0’ or ‘off’, etc.) to offload content recognition to the ACR server. The register flag may be set to true (or ‘1’ or ‘on’, etc.) once sufficient processing resources are available, or the content recognition priority is higher than another process with allocated processing resources (e.g., causing the media device to deallocate the processing resources to the other process and allocate those processes to the content recognition processes and setting the register flag to true, etc.).

If the register flag is set to true (or ‘1’ or ‘on’, etc.), then the generated cues may be processed by client ACR cue processor 212, which may be a process executed by the media device or by a device connected to the media device. If the register flag is set to false (or ‘0’ or ‘off’, etc.), then the generated cues may be processed by server ACR cue processor 216, which may be a process executed by a remote device. Client ACR cue processor 212 and server ACR cue processor 216 may process cues in a similar manner. For example, cues may be processed by comparing a cue associated with an unknown media segment to known cues associated with known media segments stored in a known cue database. A distance algorithm may be used to identify a known cue that is a closest match to the unknown cue. If the distance is within a threshold distance, then the identifier of the known media segment that corresponds to the closest matching known cue may be assigned to the unknown cue.

In some instances, if client ACR cue processor 212 could not identify a closest matching known cue within a threshold distance, then the media device may transmit the cue to server ACR cue processor 216 as server ACR cue processor 216 may include (or have access to) a larger known cue database. Alternatively, client ACR cue processor 212 may return “unknown” (or null, etc.) and the process may be repeated with another cue derived from the same media segment until a matching known cue is identified. The identifier of the known media segment may be transmitted from client ACR cue processor 212 and/or server ACR cue processor 216 (depending on which processor was selected) to context processor 220.

Context processor 220 may identify a trigger associated with the identified media segment. The trigger may identify contextual instructions to execute in association with the identified media segment. In some instances, the contextual instructions can cause the media device to present a notification (e.g., such as a request for audio input, etc.) via a display of the media device, a text message, an email, a mobile device (e.g., via an application executing on the mobile device, a push notification, etc.), instant or direct messaging, combinations or the like. Alternatively, the notification may be presented by the media segment. The contextual instructions may cause the media device to instantiate an event listener to detect an event (e.g., such as receiving audio input via audio processor 224, etc.) in association with the notification. The event listener may execute over a time interval that begins when the notification is presented and terminates some time after termination of the identified media segment. For example, the identified media segment may be a commercial that is presented for 30 seconds. Upon identify the media segment, the media device may present the notification and approximately simultaneously instantiate an event listener. The event listener may execute for a longer time interval than the media segment (e.g., such as 1 hour, 6 hours, 24 hours, etc.) to enable detecting input associated with the media segment well after the media segment terminates.

The event listener may detect audio input from audio processor 224. Audio processor 224 may be process audio segments detected by the media device and output an alphanumeric string corresponding to the audio segments. For example, audio processor 224 may include a speech-to-text model configured to translate audio segments of speech to alphanumeric strings. The event listener may detect audio input and generate event including an alphanumeric string and a timestamp corresponding to when the audio input was received. Context processor 220 may process the event to determine if the alphanumeric string corresponds to an expected alphanumeric string of the trigger (e.g., the input requested by the notification). If the alphanumeric string does not correspond to an expected alphanumeric string of the trigger, then the process may return to context processor 220 until further audio input is received.

If the alphanumeric string corresponds to an expected alphanumeric string of the trigger, then context processor 220 may facilitate context output 228, which may include execution of one or more processes of the trigger. The one or more processes may be identified in the notification and based on the particular input received. Examples of the one or more processes include, but are not limited to, present additional information associated with the identified media segment (e.g., such as a product or service featured, etc.), transmit a product object (e.g., such as a coupon for the product and/or service) to a device or user profile (e.g., email address, etc.) associated with the media device, restart the identified media segment, present a substitute media segment associated with the same product and/or service, present a substitute media segment associated with a different product or service, terminate the event listener, combinations thereof, or the like.

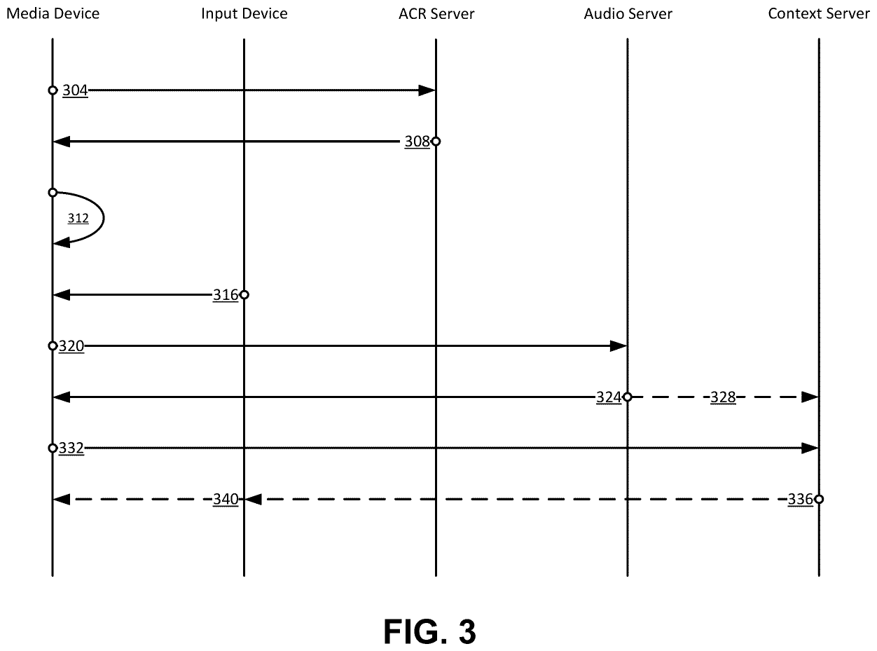

FIG. 3 illustrates a diagram of an example process for executing contextual audio processing in computing devices according to aspects of the present disclosure. A media device may initiate one or more triggers configured to execute process in response to detecting the presentation of particular media segments. The media device may define one or more triggers (e.g., based on historical viewing behavior of a user, user input, web browsing activity, instructions embedded in a media segment such metadata or watermarks, etc.). Alternatively, or additionally, the media device may receive triggers from a remote device (e.g., such as context server or other remote device). A trigger may be a data structure that defines processes to be executed in association with a particular media segment. In some examples, a trigger may include, but is not limited to, an identifier, an identification of a particular media segment, an identification of instructions for presenting a notification to the user, an identification of an event associated with the notification (e.g., particular input from a particular input source, etc.), an identification of instructions to execute in response to detecting the event, an identification of information associated with the particular media segment (e.g., such as information associated with a product or service represented in the particular media segment, an identification of actors, an identification of directors, production information, etc.), a time interval in which detection of the event will trigger execution of the instructions, an identification of a supplemental media segment to replace the particular media segment, combinations thereof, or the like.

In some instances, the trigger may include instructions that may be executed by the media device to request additional information usable to execute the trigger. The additional information may include instructions, data, supplemental media segments, etc. For example, the trigger may identify one or more application programming interfaces usable to process a particular input requested by the trigger. The media device may request the additional information to enable execution of the trigger.

The media device may begin identifying media segments presented by the media device to determine if the media segment corresponds to the media segment of a trigger. The media device may identify the media segment being presented using metadata or watermarks embedded into the media segment. A watermark may include information (or instructions) embedded within video component and/or audio component of the media segment. For example, a watermark may be embedded by modifying a chrominance and/or luminance value of a contiguous set of pixels of a video frame. The luminance (as an example) can be increased by a predetermined value to indicate a first value (e.g., such as a ‘1’) and decreased by a predetermined value to indicate a second value (e.g., such as a ‘0’). The contiguous set of pixels may be decoded into a sequence of 0's and 1's (e.g., a binary code) that may convey information such as the identification of the media segment. The metadata or watermark may include an identification of a media segment, an identification of one or more media segments to be presented in the future, a schedule of media segments, a timestamp, a time offset (indicating the position of the media segment being presented relative to a start time), etc.

If the media segment does not include metadata or watermarks, the media device may generate a cue usable to identify the media segment. The media device may generate a cue by sampling pixel data and/or audio segments from one or more video frames. The media device may generate cues in regular intervals (e.g., 1 second, 1 minute, 3 minutes, etc.) until the unknown media segment is identified. The media device may reduce the rate in which new cues are generated until it is determined that the current media segment is different from the last media segment identified and the current media segment is unknown.

At 304, the media device may transmit the unknown cues to an ACR server for identification. The ACR server may compare the unknown cue to known cues associated with known media segments. The ACR server may use a fuzzy matching algorithm to identify a closest matching known cue to the unknown cue. The fuzzy matching algorithm may be a distance algorithm, a machine-learning model, and/or the like. If the distance between the closest known cue and the unknown cue is less that a threshold, then the ACR server may assign the identifier of the known media segment of the known cue to the unknown cue.

At 308, the ACR server may transmit the identifier assigned to the unknown cue (e.g., the identifier of the known media segment of the known cue or unknown if the distance of the closest matching known cue to the known cue is not greater than the threshold) to the media device. If the media device receives an “unknown” from the ACR server, then the media device may transmit additional cues to the ACR server until an identification is returned.

The media device may determine if the identifier received from the ACR server corresponds to a particular media segment of trigger. If the identifier received from the ACR server corresponds to a particular media segment of trigger, then the media device may present a notification (e.g., via a display of the media device, a mobile device associated with the media device, a text message, email, etc.) identifying the trigger and requesting input in association with the identified media segment. The notification may be included in the trigger or retrieved in response to receiving the trigger. Alternatively, the notification may be included in the media segment.

For example, a media segment (e.g., such as an advertisement, etc.) may be associated with a trigger. Upon detecting presentation of the media segment, the media device may present (if not included in the media segment) a notification requesting the user provide an audio input contextually related to the media segment (e.g., such as to a product or service represented in the media segment, etc.) for a product object (e.g., a coupon for the product or service, etc.).

Alternatively, the media device may receive present the notification in response to detecting a watermark embedded into the media segment associated with a trigger. The media device may not require identification of the media segment (e.g., via metadata, watermarks, or automated content recognition, etc.) to perform the remaining blocks of FIG. 3 (e.g., block 312-328, etc.). In some instances, the media device may store instructions that execute in response to detecting the watermark. In other instances, the watermark may include instructions that when executed by the media device cause the media device to present the notification.

At 312, the media device may instantiate an event listener configured to monitor an interface identified by the notification. Returning to the previous example where the notification requested an audio input, the event listener may monitor an audio interface (e.g., microphone or other audio-based input device, etc.). The media device may then wait for the event listener to generate an event. The media device may be configured to instantiate event listeners configured to monitor any interface or device of the media device including, but not limited to, microphones, optical sensors, input devices (e.g., mouse, keyboard, remote control or other device configured to remotely control the operation of the media device, a gamepad, and/or the like), network interfaces of the media device (e.g., such as interfaces using Bluetooth, Ethernet, Wi-Fi, Zigbee, Z-Wave, etc.), or the like.

The event listener may execute for a predetermined time interval (e.g., defined by the trigger, user input, default setting, etc.). In some instances, the event listener may begin executing upon identifying a media segment being presented as corresponding to a trigger and terminate after termination of the media segment to enable a user more time to provide the requested input. Returning to the previous example, the media segment may be 15 seconds making it difficult for the user to provide the requesting input before the media segment terminates. The time interval may be any predetermined time interval such as, but not limited to 30 minutes, 1 hour, 6 hours, 24 hours, etc.

At 316, the event listener may detect input from an input device corresponding to the interface and generate an event. The event may include an identification of the interface that received input, the input received, a timestamp corresponding to when the event is received by the media device, and/or the like. The input may be an audio segment (e.g., spoken words or phrases, etc.), an alphanumeric string (e.g., such as a text message, email, input from a remote control, etc.), a graphic (e.g., such as a QR code, image, symbol, etc.), light or light sequence (e.g., such as a camera flash, etc.), and/or the like. The event listener may continue to execute until it is determined that the input received corresponds to the input requested.

In some instances, the media device may process the input to determine if the input received corresponds to the input requested. For example, for audio-based input, the media device may include a speech-to-text model configured to process audio segments and output alphanumeric strings. The speech-to-text model may translate words spoken by a user into text. The media device may process the audio segments into alphanumeric strings and compare the alphanumeric strings to the input requested. Alternatively, or additionally, the media device, at 320, may transmit the input to an audio server. The audio server may analyze the audio segments and, at 324, return the alphanumeric strings representing the audio segments to the media server.

In some instances, the audio server, at 328, may transmit a communication to a context server with the alphanumeric strings. The context server may determine if the alphanumeric strings correspond to the input requested. Alternatively, if the alphanumeric strings correspond to the input requested, the media device, at 332, may transmit the communication to the context server indicating the that the input received corresponds to the input requested. The context server may execute one or more processes associated with the media segment and the trigger. Returning to the previous example, the context server may transmit the product object (at 336) to an input device of the media device (e.g., a mobile device connected to the media device, remote controller, speaker, and/or the like) or to the media device (at 340). In some instances, the one or more processes may be executed by the media device.

In some instances, the trigger may identify multiple requested inputs with each requested input associated with a different one or more processes. For example, the requested input may request that the user “say pizza anytime in the next hour to receive a coupon.” If the audio input corresponds the word “pizza” then the context server may transmit the product object to the media device. If the audio input corresponds to “restart” the media device may restart or replay the media segment. The media device may reinsert the notification when restarting or replaying the media segment. Examples of process that may be executed include, but are not limited to, facilitating transmission of a product object (e.g., via an input device, the media device as an image and/or as audio, a mobile device, push notifications, text messaging, email, direct or instant messaging, combinations thereof, or the like), restarting the media segment, replaying the media segment, replacing the media segment with a supplemental media segment, providing additional information associated with the media segment (and/or products or services represented by the media segment), present a webpage associated with the media segment (e.g., over the media segment, and/or the like), and/or the like.

Upon executing the one or more processes, the media device may terminate the event listener to prevent generating duplicate events and wasting processing resources processing duplicate events.

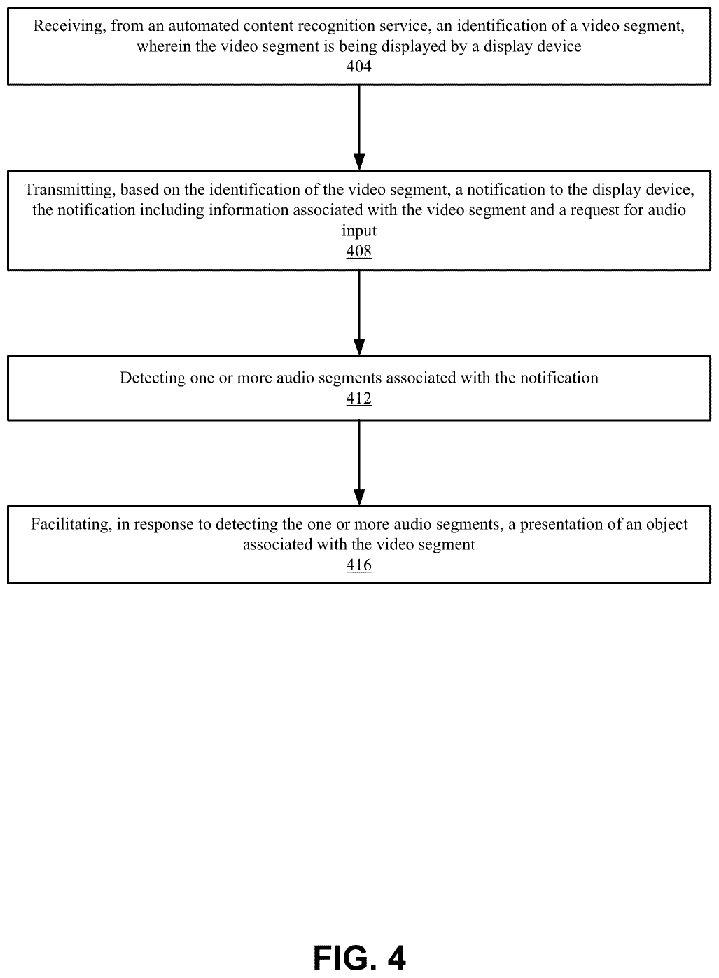

FIG. 4 illustrates a flowchart of an example process for contextual audio processing in media devices according to aspects of the present disclosure. At block 404, a media device (e.g., mobile device, tablet, computing device, television, etc.) may receive an identification of a video segment from an automated content recognition service. The identification of the video segment may correspond to a video segment that is currently being presented by the media device. For example, the media device may receive a request to initiate a trigger from a remote device. The trigger may cause the media device to execute one or more processes in response to detecting that a particular media segment is being displayed by the media device. Upon initiating a trigger, the media device may begin transmitting one or more cues derived from the video channel and/or the audio channel of the video segment to an automated content recognition service to determine if the media segment currently being presented corresponds to the particular media segment corresponding a trigger.

A cue may be a data structure that includes a representation of pixel values from one or more contiguous pixels of a video frame extracted from the video channel. Alternatively, or additionally, the data structure may include a representation of one or more audio segments extracted from an audio channel. Alternatively, or additionally, the data structure may also include metadata derived from the video segment by the media device such as, but not limited to, an identification of a channel or media source, a timestamp corresponding to generation of the cue, a time interval indicating a time since the video segmented started, information associated with the media device (e.g., an identifier of the media device, a device type of the media device, hardware and/or software installed on the media device, an Internet Protocol address, etc.), combinations thereof, or the like. The media device may then transmit the one or more cues to the automated content recognition service.

The automated content recognition service may be a component of the media device and/or a component of a remote device (e.g., such as a server, content provider, or the like). The automated content recognition service may include or have access to a database of known cues associated with known media segments. Upon receiving an unknown cue, the automated content recognition service may identify a closest matching known cue in the database (e.g., as determined by a distance algorithm, pattern matching, a machine-learning model, and/or the like). The remote device may then assign the identifier of the known media segment of the closest matching known cue to the unknown cue. The automated content recognition service may transmit the identifier to the media device.

At block 408, the media device may transmit a notification to a display device of the media device based on the identification of the video segment. The display device may be a component of the media device (e.g., the component that displays the video component of the segment). Alternatively, the display device may be a device connected to the media device (e.g., via a High-Definition Multimedia Interface (HDMI) cable, a DisplayPort cable, a network connection, etc.). Alternative, the notification may be included in the video segment (e.g., the media device may not have to do anything for the notification to be presented). Alternatively, the media device may transmit the notification to a device associated with the display device or a user thereof (e.g., such as a mobile device, etc.). The notification may include information associated with the video segment and a request for input. The notification may include alphanumeric text, an image, video, an audio segment, combinations thereof, or the like. The notification may indicate one or more options for input and one or more interfaces over which the one or more options for input may be transmitted. For example, the notification may include an alphanumeric text such as: “Say ‘pizza’ to receive a coupon for your next order”.

The media device may instantiate an event listener in response to identifying the video segment. An event listener may be a process that monitors one or more interfaces for input and generate an event in response detecting input. The event may include the input, an identification of the interface through which the input is received, a timestamp corresponding to when the input is received, combinations thereof, or the like.

At block 412, the media device may detect one or more audio segments associated with the notification. For audio-based inputs, the media device may include a speech-to-text model configured to translate audio into an alphanumeric string. The speech-to-text model may be implemented by one or more machine-learning models and/or spectral pattern matching.

The media device may compare the alphanumeric string to the requested input to determine if the requested input has been provided. Returning to the previous example, the media device may determine if the alphanumeric string includes the word “pizza”. In some instances, the media device may also determine if the alphanumeric string corresponds to common variations of the requested input (e.g., slang, different languages, synonyms, etc.). For non-audio-based inputs (e.g., text, email, input from a remote control, etc.), the media device may directly compare the input to the requested input.

In some instances, the media device may monitor for the one or more audio segments during presentation of the identified media segment. If the one or more audio segments are received after the presentation of the identified media segment terminates (e.g., the media device identifies a new media segment being presented), then media device may ignore incoming audio segments. In other instances, the media device may monitor for the one or more audio segments over a time interval that is greater than the presentation time of the identified media segment. The time interval may begin upon presentation of the notification and terminate at some time after the termination of the media segment to give a user more time to provide the requested input. For example, the time interval may be 30 minutes, 1 hour, 24 hours, etc.). The time interval may be defined when the trigger is defined and communicated to the user with the notification. Continuing the previous example, the notification may include “Say ‘pizza’ in the next 24 hours to receive a coupon for your next order”.

At block 416, the media device may then facilitate a presentation of an object associated with the video segment in response to detecting the one or more audio segments. Facilitating presentation of the object may include, but is not limited to, displaying a representation of the object (e.g., alphanumeric text, image, video, etc. associated with the object, a serial number or product code, etc.), transmitting the object to a device associated with the media device (e.g., such as a mobile device, tablet, computing device, etc.), transmitting the object to a user profile (e.g., such as an email address, a profile associated with product or service of the identified video segment, an entity identified in the identified video segment, etc.) associated with a user of the media device (e.g., such as a user identified using the one or more audio segments, etc.), combinations thereof, or the like. Returning to the previous example, after detecting the user say “pizza”, the media device may transmit the coupon to a mobile device of the user.

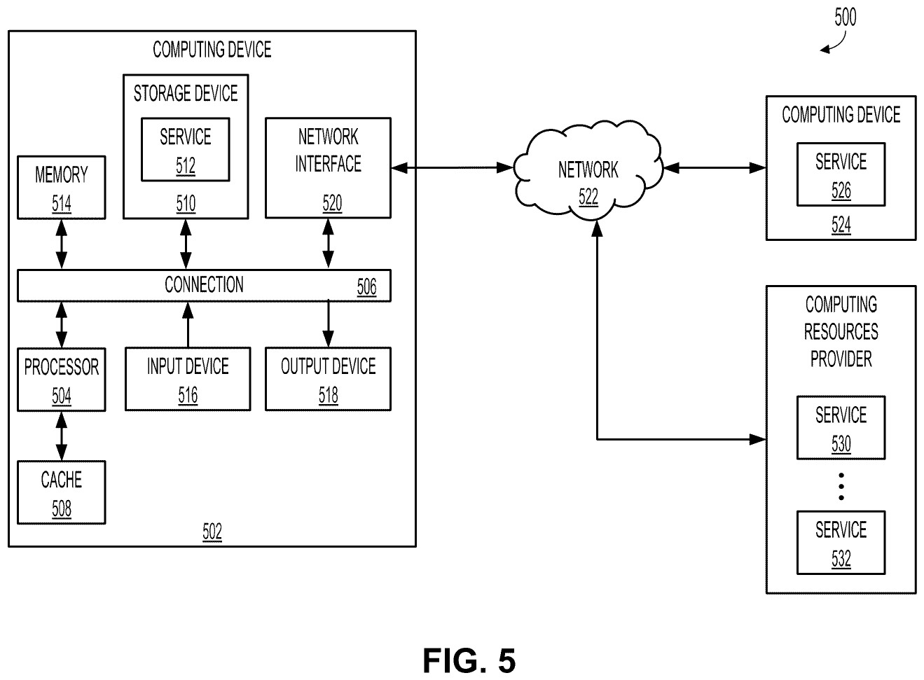

FIG. 5 illustrates a computing system architecture including various components in electrical communication with each other according to aspects of the present disclosure. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general-purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and services can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g., network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving, from an automated content recognition service, an identification of a video segment, wherein the video segment is being displayed by a display device; transmitting, based on the identification of the video segment, a notification to the display device, the notification including information associated with the video segment and a request for audio input; detecting one or more audio segments associated with the notification; and facilitating, in response to detecting the one or more audio segments, a presentation of an object associated with the video segment.

Example 2 is the method of any of example(s) 1 and 3-7, wherein facilitating the presentation of the object associated with the video segment includes displaying the object by the display device.

Example 3 is the method of any of example(s) 1-2 and 4-7, wherein facilitating the presentation of the object associated with the video segment includes executing an application by the display device, the application being configured to display a new video segment associated with the video segment.

Example 4 is the method of any of example(s) 1-3 and 5-7, further comprising: transmitting the one or more audio segments to a natural language processor configured to identify an intent corresponding to at least one of the one or more audio segments, wherein facilitating the presentation of the object associated with the video segment is further in response to identifying the intent.

Example 5 is the method of any of example(s) 1-4 and 6-7, wherein the one or more audio segments are detected within a predetermined time interval, wherein the time interval begins upon receiving the identification of the video segment.

Example 6 is the method of any of example(s) 1-5 and 7-14, wherein the notification is displayed adjacent to the video segment.

Example 7 is the method of any of example(s) 1-6 and 8-14, wherein the one or more audio segments are received from a microphone embedded within a control device configured to operate the display device.

Example 8 is the method of any of example(s) 1-7 and 9-14, wherein the one or more audio segments are received from a microphone embedded within the display device.

Example 9 is the method of any of example(s) 1-8 and 9-14, wherein the object is a coupon associated with a product or service featured in the video segment.

Example 10 is the method of any of example(s) 1-9 and 10-14, wherein the object includes additional information associated with the video segment.

Example 11 is the method of any of example(s) 1-10 and 12-14, further comprising: receiving an indication that the video segment is being presented by the display device again; and suppressing the transmission of the notification to the display device.

Example 12 is the method of any of example(s) 1-11 and 13-14, wherein facilitating the presentation of an object associated with the video segment includes: transmitting instructions that, when receive by the display device, cause the display device to display the object.

Example 13 is the method of any of example(s) 1-12 and 14, wherein facilitating the presentation of an object associated with the video segment includes: transmitting instructions that, when received by an application of a mobile device, cause the application to generate a push notification associated with the object.

Example 14 is the method of example(s) 1-13, wherein facilitating the presentation of an object associated with the video segment includes: transmitting the object via a text message or email.

Example 15 is a system comprising: one or more processors; a non-transitory computer-readable medium storing instructions that when executed by the one or more processors, cause the one or more processors to perform the methods of any of example(s) 1-14.

Example 16 is a non-transitory computer-readable medium storing instructions that when executed by one or more processors, cause the one or more processors to perform the methods of any of example(s) 1-14.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving, from an automated content recognition service, an identification of a video segment, wherein the video segment is being displayed by a display device;
transmitting, based on the identification of the video segment, a notification to the display device, the notification including information associated with the video segment and a request for audio input;
detecting one or more audio segments associated with the notification; and
facilitating, in response to detecting the one or more audio segments, a presentation of an object associated with the video segment.

2. The method of claim 1, wherein facilitating the presentation of the object associated with the video segment includes displaying the object by the display device.

3. The method of claim 1, wherein facilitating the presentation of the object associated with the video segment includes executing an application by the display device, the application being configured to display a new video segment associated with the video segment.

4. The method of claim 1, further comprising:
transmitting the one or more audio segments to a natural language processor configured to identify an intent corresponding to at least one of the one or more audio segments, wherein facilitating the presentation of the object associated with the video segment is further in response to identifying the intent.

5. The method of claim 1, wherein the one or more audio segments are detected within a predetermined time interval, wherein the time interval begins upon receiving the identification of the video segment.

6. The method of claim 1, wherein the notification is displayed adjacent to the video segment.

7. The method of claim 1, wherein the one or more audio segments are received from a microphone embedded within the display device.

8. A system comprising:
one or more processors; and
a non-transitory computer-readable medium storing instructions that when executed by the one or more processors, cause the one or more processors to perform operations including:
receiving, from an automated content recognition service, an identification of a video segment, wherein the video segment is being displayed by a display device;
transmitting, based on the identification of the video segment, a notification to the display device, the notification including information associated with the video segment and a request for audio input;
detecting one or more audio segments associated with the notification; and
facilitating, in response to detecting the one or more audio segments, a presentation of an object associated with the video segment.

9. The system of claim 8, wherein facilitating the presentation of the object associated with the video segment includes displaying the object by the display device.

10. The system of claim 8, wherein facilitating the presentation of the object associated with the video segment includes executing an application by the display device, the application being configured to display a new video segment associated with the video segment.

11. The system of claim 8, wherein the operations further include:
transmitting the one or more audio segments to a natural language processor configured to identify an intent corresponding to at least one of the one or more audio segments, wherein facilitating the presentation of the object associated with the video segment is further in response to identifying the intent.

12. The system of claim 8, wherein the one or more audio segments are detected within a predetermined time interval, wherein the time interval begins upon receiving the identification of the video segment.

13. The system of claim 8, wherein the notification is displayed adjacent to the video segment.

14. The system of claim 8, wherein the one or more audio segments are received from a microphone embedded within the display device.

15. A non-transitory computer-readable medium storing instructions that when executed by one or more processors, cause the one or more processors to perform operations including:
receiving, from an automated content recognition service, an identification of a video segment, wherein the video segment is being displayed by a display device;
transmitting, based on the identification of the video segment, a notification to the display device, the notification including information associated with the video segment and a request for audio input;
detecting one or more audio segments associated with the notification; and
facilitating, in response to detecting the one or more audio segments, a presentation of an object associated with the video segment.

16. The non-transitory computer-readable medium of claim 15, wherein facilitating the presentation of the object associated with the video segment includes displaying the object by the display device.

17. The non-transitory computer-readable medium of claim 15, wherein facilitating the presentation of the object associated with the video segment includes executing an application by the display device, the application being configured to display a new video segment associated with the video segment.

18. The non-transitory computer-readable medium of claim 15, wherein the operations further include:
transmitting the one or more audio segments to a natural language processor configured to identify an intent corresponding to at least one of the one or more audio segments, wherein facilitating the presentation of the object associated with the video segment is further in response to identifying the intent.

19. The non-transitory computer-readable medium of claim 15, wherein the one or more audio segments are detected within a predetermined time interval, wherein the time interval begins upon receiving the identification of the video segment.

20. The non-transitory computer-readable medium of claim 15, wherein the one or more audio segments are received from a microphone embedded within the display device.
